(19) United States
(12) Patent Application Publication
(10) Pub. No.: US 2012/0317642 A1
(43) Pub. Date: Dec. 13, 2012

(54) Parallel Tracing Apparatus For Malicious Websites

(75) Inventors: PAUL ROYAL, MARIETTA, GA (US); Paul Judge, Atlanta, GA (US)

(73) Assignee: BARRACUDA NETWORKS, INC., CAMPBELL, CA (US)

(21) Appl. No.: 13/156,340

(22) Filed: Jun. 9, 2011

(51) Int. Cl. G06F 21/00

(52) U.S. Cl. 726/22

(57) ABSTRACT

An apparatus and system for scoring and grading websites and method of operation. An apparatus receives one or more Uniform Resource Identifiers (URI), requests and receives a resource such as a webpage, and observes the behaviors of a commercial browser operating within a commercial operating system over a multi-core processor having hardware containing virtualization extensions. The apparatus records and stores objects and packets captured while the browser is controlled by software received from a server accessed via the URI.

### RELATED APPLICATIONS

None

### BACKGROUND

In computer security, it is known that although it is possible to enable a single processor computer to connect with a website at a Uniform Resource Identifier to analyze malicious software downloaded to the computer, that approach does not scale to keep pace with the geometric growth of domains on the Internet.

Conventional solutions for detecting malware install software which was unknown or suspicious into virtual machines for analysis. Unfortunately developers of malicious code seem to have determined ways to detect the difference between real and virtual machines and learned how to quiesce malicious behavior within test environments.

What is needed is a scalable architecture for an improved apparatus with greater parallelism and economic efficiency to determine whether a website is malicious by determining whether a browser (or one of its plugins) receiving a resource from the website is used in a way that results in the download of malicious software especially for malicious software configured to identify conventional virtual testbeds and browser emulators.

### BRIEF DESCRIPTION OF FIGURES

The appended claims set forth the features of the invention with particularity. The invention, together with its advantages, may be best understood from the following detailed description taken in conjunction with the accompanying drawings of which:

FIG. 1 is a schematic of a system in which the apparatus operates;

FIGS. 2-4 are block diagrams of components of an apparatus; and

FIGS. 5-7 are flow charts of a method embodiments for controlling a processor embodiment.

### SUMMARY OF THE INVENTION

One aspect of the invention is an apparatus and system for scoring and grading websites and method of operation. An apparatus receives one or more Uniform Resource Identifiers (URIs), requests and receives a resource such as web page, and observes the behaviors of a commercial browser as controlled by software received from a server associated with the URI. The apparatus receives a list of URIs, generates a thread for each one, generates a virtual machine for each thread, assigns a MAC address for a virtual network interface card, enables selected access to the underlying hardware, and records and stores object and packet capture files for subsequent analysis.

### DETAILED DISCLOSURE OF EMBODIMENTS OF THE INVENTION

While non-hardware virtualization extensions-based virtual machines scale effectively for testing software, developers of malicious code have added capabilities to test an environment for characteristics of real hardware underlying a non-test software environment before enabling observably malicious actions.

Although the invention uses commercial multi-core processors, it uses them in an unconventional way and provides a novel software environment which scalably operates a much larger number of virtual machines than the number of cores and determines whether a website is malicious by observing whether a commercial browser (not an emulator) or its plug-ins is controlled in a way that results in the download of malicious software.

One aspect of the invention is an apparatus comprising an array of multi-core processors configured to evaluate Uniform Resource Identifiers (URIs) according to behavior of content (including but not limited to software) downloaded from a website related to the URI into an actual commercial browser running in an actual commercial operating system. This behavior includes packets transmitted to and from the operating system and software that runs inside it (including but not limited to the browser) which said packets are recorded for later analysis.

The invention is easily distinguished from conventional website analysis which does not operate an actual commercial browser in an actual commercial operating system. (e.g. IE in WINE in Linux).

One embodiment of the invention is an apparatus which has:

an array of processors, each processor comprising a multi-core processor, each core having one or more hardware virtualization extension circuits;

a link circuit communicatively coupled to each core of each processor in the array of processors, whereby packets may be transmitted to and received from a wide area network such as the Internet; whereby any process operating on any core has Internet connectivity; and

a packet capture circuit coupled to the link circuit, whereby traffic out of and into the array of processors is received, inspected, and stored.

In an embodiment, a processor configured by a conventional tcpdump software application known in the art stores packets. In an embodiment a processor configured by a packet capture file parsing library subsequently examines packets.

The apparatus further comprises:

an artifacts logging circuit communicatively coupled to the packet capture circuit and to the array of processors, configured to at least:

receive and store a Uniform Resource Identifier (URI) request emitted from a processor, wherein a URI comprises at least a protocol, and a fully qualified domain name, to a URI store for further analysis.

The apparatus further comprises:

a processor configured to receive and store a webserver response to a URI; and to log any additional packets emitted by the processor or transmitted to the processor into an object and packet capture store for further analysis; and

a control circuit coupled to the array of processors.

A control circuit receives a URI for analysis. The control circuit has a thread generation circuit. The control circuit assigns this URI to a thread. The thread creates a Virtual Machine to process the URI. The control circuit has an assignment circuit to assign a MAC address of a virtual network interface card to each Virtual Machine. The control circuit maintains a file which maps each URI to a MAC address of a virtual network interface card. Using a kernel scheduler of a kernel-based virtual machine software product, known in the art, each virtual machine is a process which may be assigned to any core of the multi-core processor.

In an embodiment, an aspect of the invention utilizes Advanced Micro Devices' SVM technology to perform a double-sided host/guest page table traversal. In an embodiment, an aspect of the invention utilizes Intel's VT virtualization extensions and Extended Page Tables. In an embodiment, equivalent functionality in an ARM core could be used. An aspect of the invention is cross-use of a hardware feature provided to accelerate virtual machines operations to defeat malicious content which probes for real vs virtual divergences. The apparatus further comprises a virtual disk array which has a cold cache and a hot cache. The cold cache is the read-side of a copy-on-write virtual disk image stored on a ramfs mount which contains a memory image of a commercial operating system and a commercial browser. In an embodiment, the hot cache is the location where KVM VMs store writes to the write-side of the copy-on-write virtual disk image. Each virtual machine has a unique hot cache and shares the cold cache with each other virtual machine. This provides scaling. Each virtual machine is active until the execution timeout occurs and they are killed.

In an embodiment the control circuit further comprises:

a mouse movement, and keyboard emulation circuit to inject events into each instance of a browser.

In an embodiment, the control circuit further comprises:

a timer to complete each test of a URI, terminate a virtual machine, and select a new URI to test; whereby a thread generator generates a thread for the URI, and said thread generates a virtual machine for the URI and assigns a virtual MAC address to the virtual machine to process the URI; and

a kernel scheduler function which allocates each virtual machine to an available core when needed.

In an embodiment the apparatus further comprises a processor configured to operate as

a VNCSnapshot utility whereby a screen capture control circuit determines that a screen displayed from a browser is to be captured by the artifacts logging circuit.

In an embodiment the apparatus further comprises:

an analysis and reporting circuit communicatively coupled to the packet capture circuit, to the artifacts logging circuit, and to the control circuit configured to:

receive and dedup screen captures;

identify references to dynamic dns services; and

recognize anomalous data flows through the link.

In an embodiment, the control circuit is further configured to record evidence of software provided by a server at a URI to control a browser to download a binary executable program (especially one which attempts to send electronic mail); and

a malicious behavior scoring circuit to assign a score to each URI which has been traced.

A system is disclosed to score and grade websites by observation of behaviors in a commercial browser running within a commercial operating system using x86 hardware containing virtualization extensions. A system is disclosed to score and grade websites, the system comprising an apparatus communicatively coupled to a wide area network to receive and send packets under control of a resource received from a server accessed by a URI referring to said website; and within said apparatus operating a commercial browser running within a commercial operating system whereby said resource accesses x86 hardware containing virtualization extensions, and recording said packets to analyze for malicious intent.

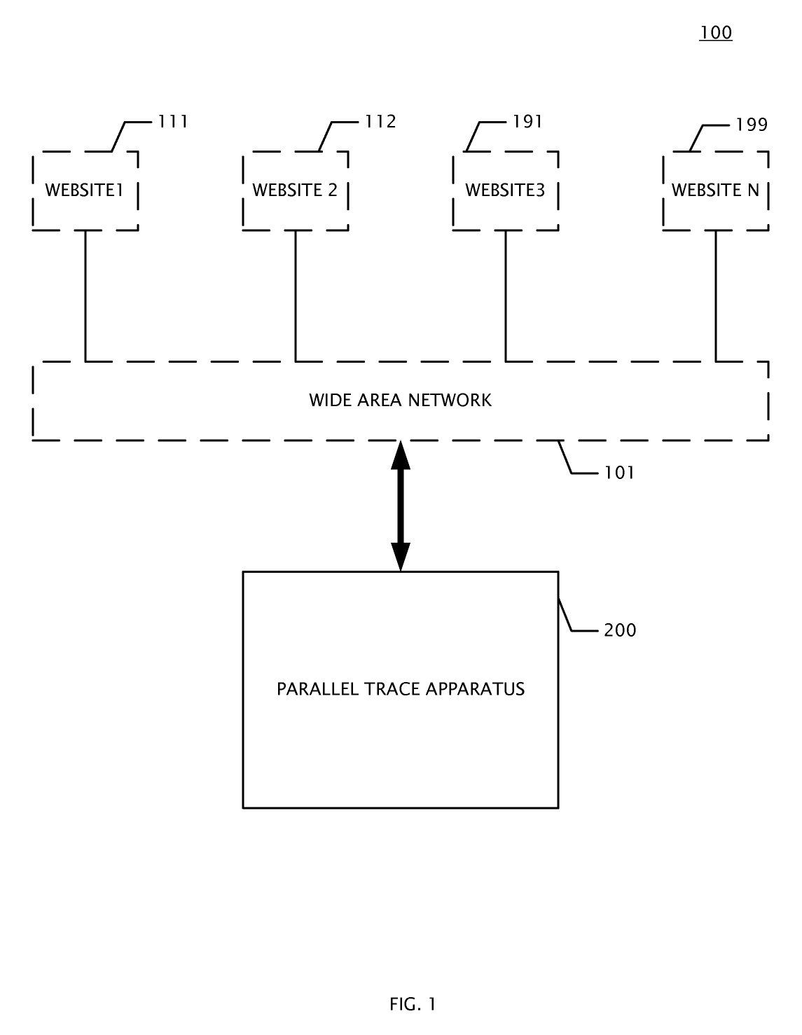

Referring to FIG. 1, a block diagram illustrates a system within which the invention is used. A wide area network, such as the Internet 101 communicatively couples a very large number of website 111-199 to a parallel trace apparatus 200. The parallel trace apparatus receives a list of Uniform Resource Identifiers of objects located on some of the websites and is tasked with determining if the content or documents demonstrate hostile intent to any visitor.

The apparatus is provided to score and to grade a website comprising a URI access circuit configured to:
receive at least one Uniform Resource Identifiers (URI),
request said URI and
receive a resource,
and observe the behavior of a commercial browser as enabled by content (including but not limited to software) received from a server associated with the URI.

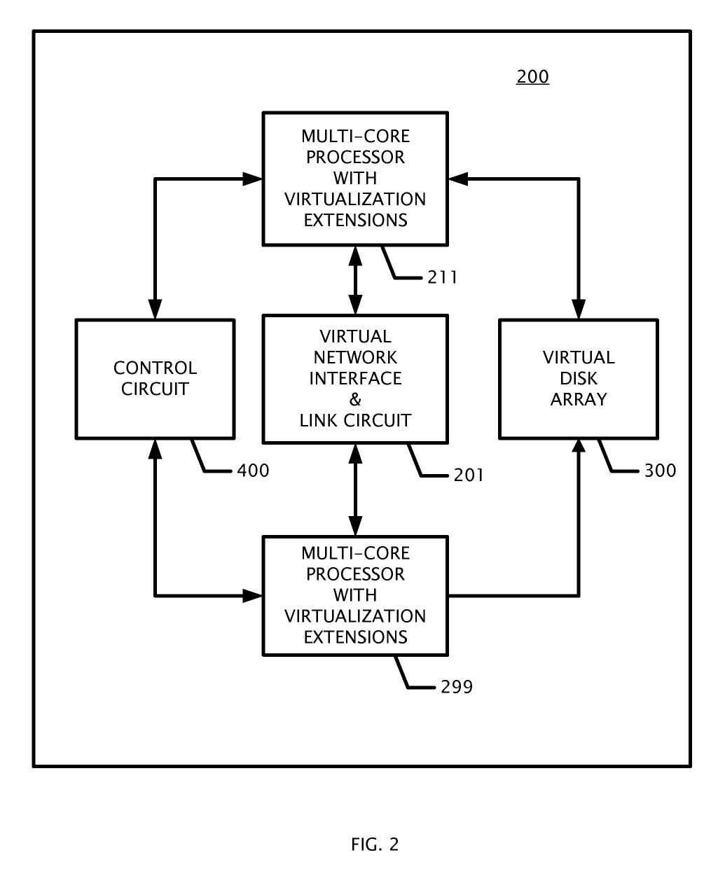

FIG. 2 illustrates one embodiment of a block diagram of a parallel trace apparatus. A parallel trace apparatus comprises a plurality of multi-core processors with virtualization extensions 211-299. Each multi-core processor comprises a plurality of cores all communicatively coupled to a virtual disk array 300, and to a control circuit 400 and to a virtual network interface and link circuit 201. In such an apparatus, a plurality of commercial multi-core processors, is configured by a software environment which scalably operates a much larger number of virtual machines than the number of cores to determine whether a website is malicious by observing whether a commercial browser or its plug-ins is controlled in a way that results in the download of malicious software. An apparatus comprising an array of multi-core processors configured to evaluate Uniform Resource Identifiers (URIs) according to behavior of content (including but not limited to software) downloaded from a website related to the URI into an actual commercial browser running in an actual commercial operating system which records packets transmitted to and from the browser for later analysis.

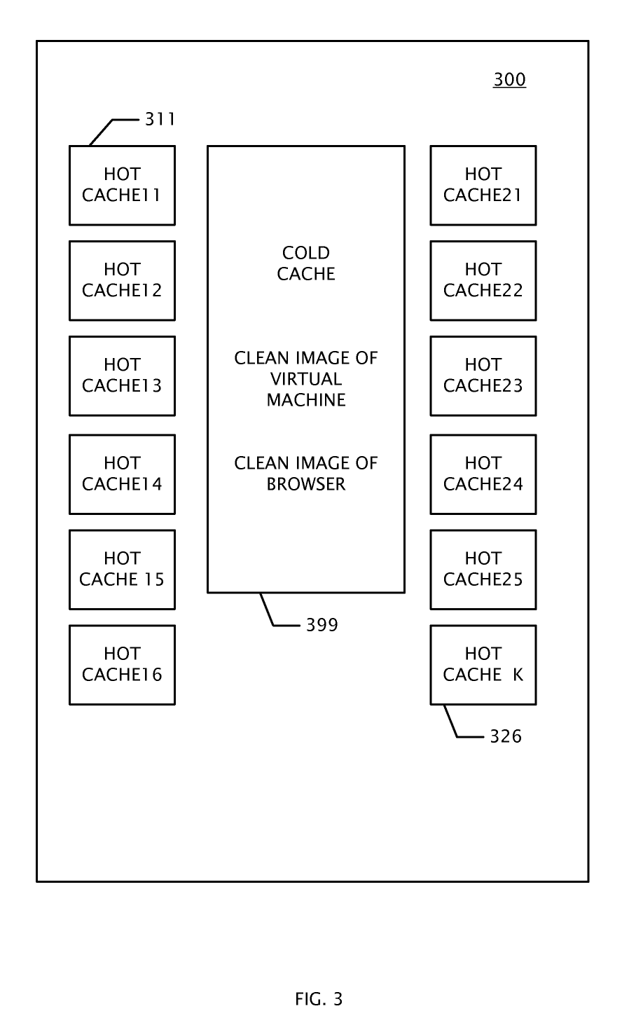

FIG. 3 is a schematic of a virtual disk array. A virtual disk array 300 comprises a cold cache store which contains a clean image of a commercial virtual machine operating system and a clean image of a commercial browser and its plugins. When a new virtual machine is started to analyze a URI, it is initialized from the cold cache 399. However, as the virtual machine operates on a specific URI, data in the virtual machine memory is changed according to the contents received from the server accessed via the URI. Rather than writing into the clean image, each instantiated virtual machine writes to a hot cache assigned to it 311-326. In an embodiment, the cold cache is the read-side of a copy on write virtual disk image stored on a ramfs mount. Each virtual machine has a unique hot cache but shares the cold cache with all other virtual machines.

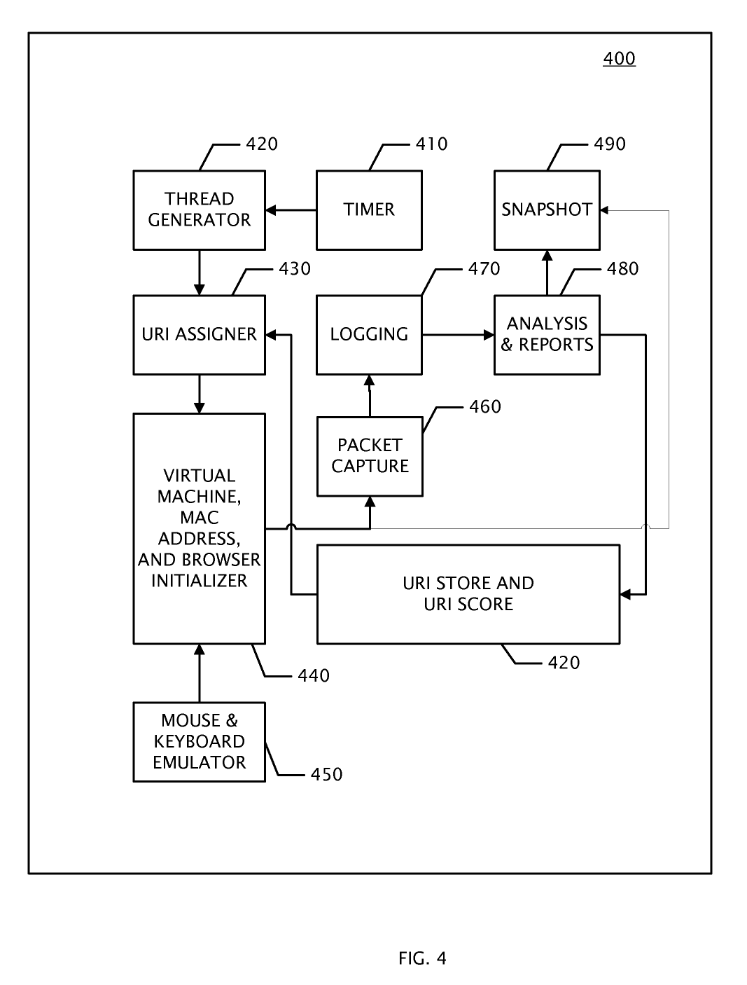

FIG. 4 is a block diagram of a control circuit. A control circuit 400 in an embodiment, a processor configured by instructions, comprises:
a timer 410; communicatively coupled to
a thread generator 420; communicatively coupled to
a URI assigner 430; which is first coupled to a URI store 420 and also coupled to
a virtual machine, MAC address, and browser initializer 440; which receives events generated by a mouse and keyboard emulator 450 which cause a browser to request and receive content using initially the URI and subsequently, the content received from the URI.

The control circuit further comprises a packet capture circuit 460; communicatively coupled to a logging circuit 470 whereby all packets transmitted and received by the virtual machine are recorded.

The control circuit further comprises an analysis and reports circuit which determines if there is hostile behavior observed in the logged packets 480 and is communicatively coupled to the URI store and URI score 420. In an embodiment, the analysis and reports circuit is further coupled to a snapshot circuit 490 to record screenshots of behaviors which are considered either anomalous or displaying hostile intent. In an embodiment the virtual machine, mac address, and browser initializer circuit 440 is coupled to the snapshot circuit 490.

In an embodiment, the control circuit is configured to
generate a thread for each URI,
generate a virtual machine for each thread,
assign a MAC address for a virtual network interface card,
enable selected access to the underlying hardware, and
record and store object and packet capture files for subsequent analysis.

In an embodiment the apparatus comprises an array of processors, wherein each of said processors comprises a multi-core processor, each core having one or more hardware virtualization extension circuits; said processor further comprises
a link circuit communicatively coupled to each core of each processor in the array of processors, whereby packets may be transmitted to and received from a wide area network such as the Internet; whereby any process operating on any core has Internet connectivity; and
a packet capture circuit coupled to the link circuit, whereby traffic out of and into the array of processors is received, inspected, and stored.

In an embodiment a processor is configured by a conventional tcpdump software application known in the art to store packets.

In an embodiment the processor is configured by a packet capture file parsing library to examine packets.

In an embodiment the apparatus further comprises:

an artifacts logging circuit communicatively coupled to the packet capture circuit and to the array of processors, configured to at least:
receive and store a Uniform Resource Identifier (URI) request emitted from a processor, wherein a URI comprises at least a protocol, and a fully qualified domain name, to a URI store for further analysis.

In an embodiment the processor is configured to receive and store a webserver response to a URI; and to log any additional packets emitted by the processor or transmitted to the processor into an object and packet capture store for further analysis.

In an embodiment, a kernel scheduler of a kernel-based virtual machine software product may utilize any available core of the multi-core processor comprised of hardware virtualization extensions such as but not limited to Intel's VT virtualization extensions and Extended Page Tables or Advanced Micro Devices' SVM technology which performs a double-sided host/guest page table traversal.

In an embodiment the control circuit comprises: a mouse movement, and keyboard emulation circuit to inject events into each instance of a browser and a timer to complete each test of a URI, terminate a virtual machine, and select a new URI to test whereby a thread generator generates a thread for the URI, and said thread generates a virtual machine for the URI and assigns a virtual MAC address to the virtual machine to process the URI; and

a kernel scheduler function which allocates each virtual machine to an available core when needed.

In an embodiment, the apparatus comprises a processor configured to operate as a VNCSnapshot utility whereby a screen capture control circuit determines that a screen displayed from a browser is to be captured by the artifacts logging circuit.

In an embodiment the analysis and reporting circuit communicatively coupled to the packet capture circuit, to the artifacts logging circuit, and to the control circuit is configured to:
receive and dedup screen captures;
identify references to dynamic dns services; and
recognize anomalous data flows through the link.

In an embodiment the control circuit is further configured to record evidence of content provided by a server at a URI to enable a browser to download a binary executable program which attempts to send electronic mail; and includes a malicious behavior scoring circuit to assign a score to each URI which has been traced.

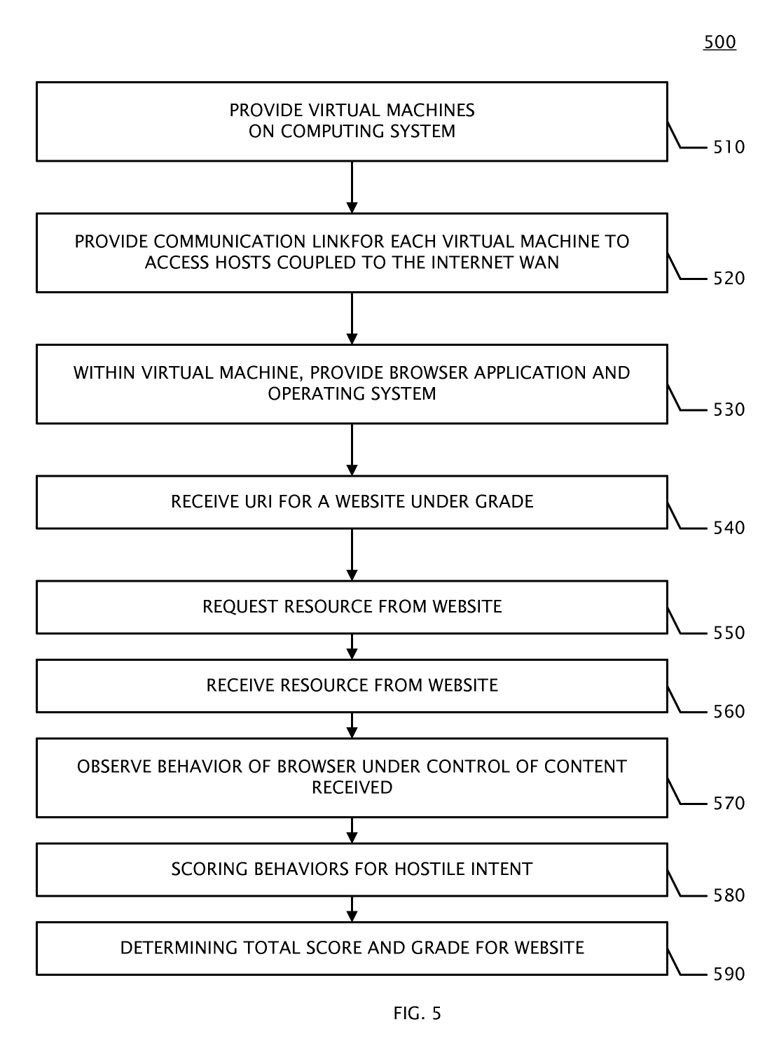

FIG. 5 is a flow chart of a method embodiment of the invention. Referring now to FIG. 5, an aspect of the invention is a method for scoring and grading websites by observing script behaviors in a commercial browser application executing in a commercial operating system with access to underlying hardware virtualization extensions. The method comprises:
providing one or more virtual machines on a computing system comprising a processor configured by an operating system 510;
providing a communications link for each virtual machine to access hosts coupled to the Internet 520;
within a virtual machine, providing a browser application 530;
   operating said browser to:
receive a Uniform Resource Identifier (URI) for a website for which the content is to be graded for hostile intent, wherein a URI comprises a protocol and a domain name 540;
request by the browser a resource from said website 550;
receiving said resource, such as content or software;
observing a behavior of the browser as controlled by said content contained within said resource 570 and
scoring said behaviors for hostile intent 580.

In an embodiment, the method further comprises:
determining a total score for a website from the scores of the packets received by or transmitted from a browser, and
determining a grade for the website by comparing the total score to one or more thresholds 590.

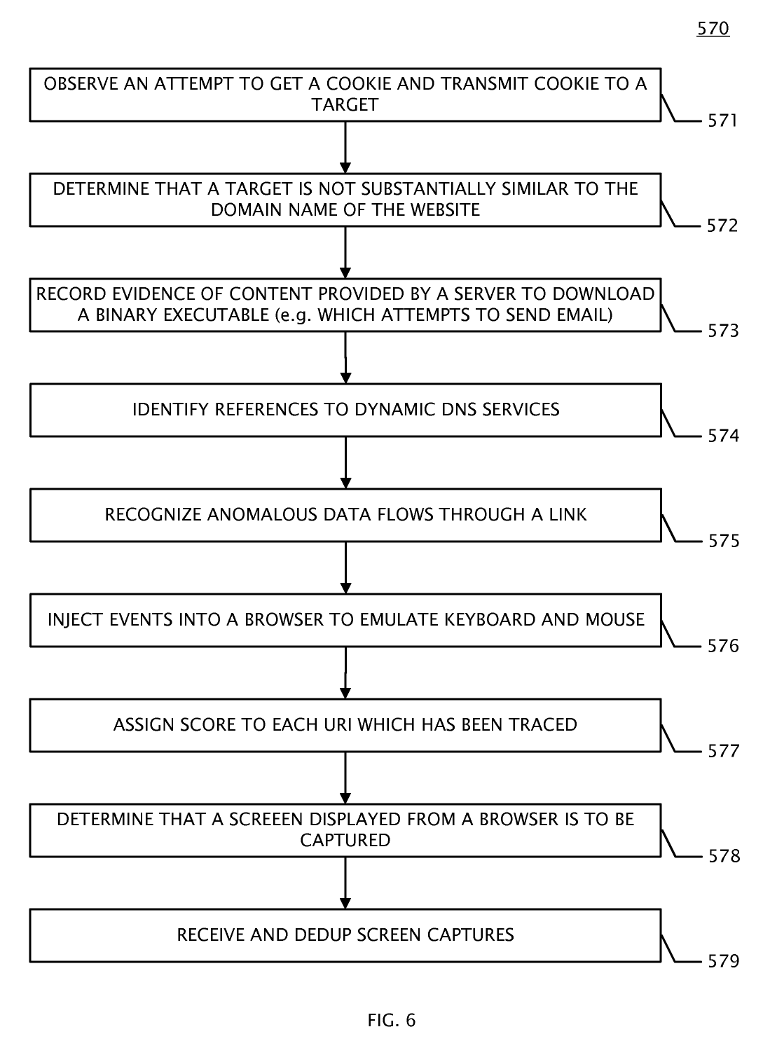

Referring to FIG. 6 the method may include the following:
observing an attempt to get a cookie and transmit said cookie to a target 571;
determining that said target is a host not substantially similar to the domain name of the website 572.

In an embodiment, the method comprises
recording evidence of content provided by a server at a URI to enable a browser to download a binary executable (which may inter alia attempt to send electronic mail) 573;
identify reference to dynamic DNS services 574;
recognize anomalous data flows through a link 575;
inject events into a browser to emulate keyboard and mouse 576;
assign a score to each URI which has been traced 577;
determine that a screen displayed from a browser is to be captured 578; and
receive and delete duplicate screen captures 579.

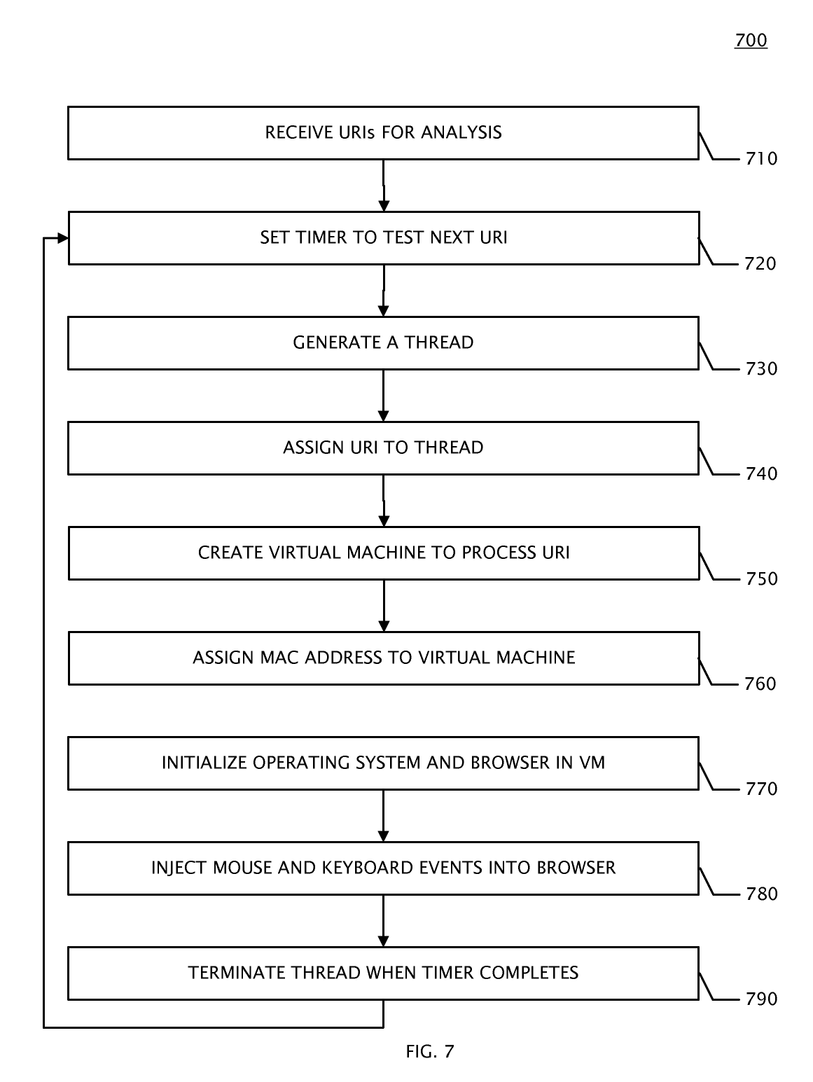

Referring now to FIG. 7, a method for operation of a control circuit comprises:
Receiving a plurality of Uniform Resource Identifiers (URIs) for analysis 710;
setting a timer to test each next URI 720;
generating a thread for each URI 730;
assigning a URI to each generated thread 740;
for each thread, creating a virtual machine (VM) to process each URI 750;
assigning a MAC address for a virtual network interface to each virtual machine 760;
initializing a commercial operating system and a commercial browser in each VM 770;
in an embodiment, injection mouse and keyboard events into the browser 780; and
terminating the thread when the timer completes and selecting the next received URI for analysis 790.

### Means, Embodiments, and Structures

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a non-transitory computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

### CONCLUSION

A conventional system isolates potentially malicious software in a browser emulator or a virtual machine which provides no access to the underlying processor. This can be discovered by the malicious software and the malicious behavior is not demonstrated in such a test environment.

The invention is easily distinguished from conventional website analysis which does not operate an actual commercial browser in an actual commercial operating system. (e.g. IE in WINE in Linux).

The invention can be easily distinguished from solutions that observe effects on the hardware or software configuration of the host.

What is claimed is:

1. An apparatus to score and to grade a website comprising a URI access circuit configured to:
receive at least one Uniform Resource Identifiers (URI),
request said URI and
receive a resource,
and observe the behavior of a commercial browser as controlled by software received from a server associated with the URI, said receiver circuit configured to
generate a thread for each URI,
generate a virtual machine for each thread,
assign a MAC address for a virtual network interface card,
enable selected access to the underlying hardware, and
record and store object and packet capture files for subsequent analysis.

2. An apparatus comprising commercial multi-core processors, configured by a software environment which scalably operates a much larger number of virtual machines than the number of cores to determine whether a website is malicious by observing whether a commercial browser or its plug-ins is controlled in a way that results in the download of malicious software.

3. An apparatus comprising an array of multi-core processors configured to evaluate Uniform Resource Identifiers (URIs) according to behavior of content (including but not limited to software) downloaded from a website related to the URI into an actual commercial browser running in an actual commercial operating system which records packets transmitted to and from the browser for later analysis.

4. An apparatus comprised of an array of processors, wherein each of said processors comprises a multi-core processor, each core having one or more hardware virtualization extension circuits; said processor further comprised of
a link circuit communicatively coupled to each core of each processor in the array of processors, whereby packets may be transmitted to and received from a wide area network such as the Internet; whereby any process operating on any core has Internet connectivity; and
a packet capture circuit coupled to the link circuit, whereby traffic out of and into the array of processors is received, inspected, and stored.

5. The processor of claim 4 configured by a conventional tcpdump software application known in the art stores packets.

6. The processor of claim 4 configured by a packet capture file parsing library subsequently examines packets.

7. The apparatus of 4 claim further comprises:
an artifacts logging circuit communicatively coupled to the packet capture circuit and to the array of processors, configured to at least:
receive and store a Uniform Resource Identifier (URI) request emitted from a processor, wherein a URI comprises at least a protocol, and a fully qualified domain name, to a URI store for further analysis.

8. The apparatus of claim 4 further comprises:
a processor configured to receive and store a webserver response to a URI; and to log any additional packets emitted by the processor or transmitted to the processor into an object and packet capture store for further analysis; and
a control circuit coupled to the array of processors.

9. The control circuit of claim 8 further comprises a processor configured to:
receive a URI for analysis; generate a thread; assign said URI to the thread; create a Virtual Machine to request and process the URI; and assign a MAC address of a virtual network interface card to each Virtual Machine, whereby a kernel scheduler of a kernel-based virtual machine software product may utilize any available core of the multi-core processor.

10. The apparatus of claim 9 wherein the multi-core processor is a processor comprised of hardware virtualization extensions.

11. The apparatus of claim 10 wherein a processor comprised of hardware virtualization extensions is Intel's VT virtualization extensions and Extended Page Tables.

12. The apparatus of claim 10 wherein a processor comprised of hardware virtualization extensions is Advanced Micro Devices' SVM technology which performs a double-sided host/guest page table traversal.

13. The apparatus of claim 4 further comprises a virtual disk array which has a cold cache and a hot cache wherein the cold cache is the read-side of a copy-on-write virtual disk image stored on a ramfs mount which contains a memory image of a commercial operating system and a commercial browser.

14. The apparatus of claim 5 wherein the hot cache is a location where KVM VMs store writes to the write-side of the copy-on-write virtual disk image, whereby each virtual machine has a unique hot cache and shares the cold cache with each other virtual machine.

15. The apparatus of claim 8 wherein the control circuit further comprises:
a mouse movement, and keyboard emulation circuit to inject events into each instance of a browser.

16. The apparatus of claim 8 wherein the control circuit further comprises:
a timer to complete each test of a URI, terminate a virtual machine, and select a new URI to test whereby a thread generator generates a thread for the URI, and said thread generates a virtual machine for the URI and assigns a virtual MAC address to the virtual machine to process the URI; and
a kernel scheduler function which allocates each virtual machine to an available core when needed.

17. The apparatus of claim 4 further comprises a processor configured to operate as
a VNCSnapshot utility whereby a screen capture control circuit determines that a screen displayed from a browser is to be captured by the artifacts logging circuit.

18. The apparatus of claim 17 further comprises:
an analysis and reporting circuit communicatively coupled to the packet capture circuit, to the artifacts logging circuit, and to the control circuit configured to:
receive and dedup screen captures;
identify references to dynamic dns services; and
recognize anomalous data flows through the link.

19. The apparatus of claim 16 wherein the control circuit is further configured to record evidence of content provided by a server at a URI to control a browser to download a binary executable program which attempts to send electronic mail; and
a malicious behavior scoring circuit to assign a score to each URI which has been traced.

20. A system is disclosed to score and grade websites, the system comprising an apparatus communicatively coupled to a wide area network to receive and send packets under control of a resource received from a server accessed by a Uniform Resource Identifier (URI) referring to said website; and within said apparatus operating a commercial browser running within a commercial operating system whereby said resource accesses x86 hardware containing virtualization extensions, and recording said packets to analyze for malicious intent.

21. A method for scoring and grading websites by observing script behaviors in a commercial browser application executing in a commercial operating system with access to underlying hardware virtualization extensions, the method comprising:
providing one or more virtual machines on a computing system comprising a processor configured by an operating system;
providing a communications link for each virtual machine to access hosts coupled to the Internet;
within a virtual machine, providing a browser application wherein said browser operates as follows:
receiving a Uniform Resource Identifier (URI) for a website for which the content is to be graded for hostile intent, wherein a URI comprises a protocol and a fully qualified domain name;
requesting by the browser a resource from said website;
receiving said resource;
observing a behavior of the browser as controlled by said code contained within said resource and
scoring said behaviors for hostile intent.

22. The method of claim 21 wherein
a behavior comprises:
attempting to get a cookie and transmit said cookie to a target.

23. The method of claim 22 further comprising:
determining that said target is a host not substantially similar to the domain name of the website.

24. The method of claim 21 further comprising:
determining a total score for a website from the scores of the packets received by or transmitted from a browser, and
determining a grade for the website by comparing the total score to one or more thresholds.

25. An apparatus to score and grade websites by observation of behaviors in a browser, comprising:
one or more virtual machines on a computing system comprising a processor configured by an operating system;
a communications link for each virtual machine to access hosts coupled to the Internet;
within a virtual machine, a browser application to execute instructions received by accessing a URI.

26. A system to score and grade websites by observation and analysis of packets transferred to and from a browser, comprising:
one or more virtual machines on a computing system comprising a multicore processor having virtualization extensions configured by an operating system;
a communications link for each virtual machine to access hosts coupled to the Internet;
within a virtual machine, a commercial browser application which transmits to and receives from the Internet according to the content received from a server accessed by a URI.
